(19) United States
(12) Patent Application Publication
(10) Pub. No.: US 2019/0056004 A1
(43) Pub. Date: Feb. 21, 2019

(54) PRESSED POWDER TITANIUM BRAKE ROTOR

(71) Applicant: Gerald Martino, Mt. Pleasant, PA (US)

(72) Inventor: Gerald Martino, Mt. Pleasant, PA (US)

(21) Appl. No.: 16/104,659

(22) Filed: Aug. 17, 2018

Related U.S. Application Data
(60) Provisional application No. 62/546,650, filed on Aug. 17, 2017.

(51) Int. Cl. F16D 65/12; B33Y 80/00; B33Y 70/00; C22C 14/00

(52) U.S. Cl. CPC F16D 65/125; F16D 65/126; B33Y 80/00; F16D 2065/132; C22C 14/00; F16D 2250/00; F16D 2200/0026; B33Y 70/00

(57) ABSTRACT

A vehicular brake rotor component made from a Ti base powder alloy which has been 3D printed to a desired shape before one or both of its wear surfaces are coated with a 0.005 to 0.01 inch thick mixture containing about 1-40% chromium carbine. Then the combined product is sintered, machined and double disc ground. Related methods of manufacture of this brake rotor component are also disclosed.

### CROSS-REFERENCE TO RELATED APPLICATION

This is a perfection of U.S. Provisional Application Ser. No. 62/546,650, filed on Aug. 17, 2018, the disclosure of which is fully incorporated by reference herein.

### FIELD OF THE INVENTION

This invention relates to manufacturing vehicular parts, more particularly vehicular (truck and/or automotive) brake rotor assemblies. Such vehicular brake rotors may be made by Pressing Ti Powders and then sintering the same. Or, in the alternative, they may be made by 3-D printing and/or laser printed.

### BACKGROUND OF THE INVENTION

Traditionally automotive brake rotors have been made using cast iron. They are well known to provide good wear resistance and high temperature properties. However, cast iron is dense relative to other materials so that a cast iron brake rotor is heavy. A heavy brake rotor is undesirable for at least three reasons: (1) a heavy brake rotor contributes to the overall weight of a motor vehicle thus reducing its fuel efficiency and increasing its emissions. (2) a brake rotor is part of the unsprung vehicle weight, meaning the weight below the springs. Unsprung weight adds to the noise, vibration, and harshness (sometimes referred to as “NVH”) associated with vehicle operation. When unsprung weight is reduced, NVH usually improves. (3) a brake rotor is a vehicle part that requires rotation during use. Accordingly, a heavier brake rotor requires additional energy to increase and decrease rotational speed. Reducing weight of a vehicle rotor also lowers vibration during rotation. Carbon-carbon composites, ceramics, and “cermets” have been considered for use in brake rotors but they are expensive and have not achieved widespread adoption as vehicle rotors.

Titanium has been considered as brake rotor material per Murphy U.S. Pat. No. 5,521,015 and Martino U.S. Pat. No. 5,901,818, both incorporated by reference herein. Titanium has excellent strength-to-weight properties, and it retains strength at high temperatures. However, high costs have heretofore prevented widespread adoption of titanium and its alloys in vehicle brake rotors. Accordingly there still remains a great need for a low cost process for manufacturing titanium brake rotors.

Other brake rotors are shown in U.S. Pat. No. 4,278,153, which discloses a brake disc frictional module composed of sintered metallic material reinforced throughout its entire volume by a grid system of pure metal or metallic alloy. The friction module may be manufactured by sintering the metallic material with the grid reinforcement in either a mold or within the brake disc cup. The internal reinforcement of the frictional module prevents spalling weight loss, friction coefficient decay, or other physical defects caused by frictional strain during use. The reinforcement material reduces the overall temperature of the disc during use, and aids frictional coefficient of the disc because of the metallic compatibility of the metallic material and grid system.

U.S. Pat. No. 5,620,791 discloses metal and ceramic matrix composite brake rotors comprising an interconnected matrix embedding at least one filler material. In the case of metal matrix composite materials, at least one filler material comprises at least about 26% by volume of the brake rotor for most applications, and at least about 20% by volume for applications involving passenger cars and trucks.

U.S. Pat. No. 4,381,942 discloses a process for the production of titanium-based alloy members by powder metallurgy. It consists of: (a) preparing a titanium or titanium alloy powder having a certain grain size distribution, (b) depositing on said powder a coating of a material such that on contact with the titanium or titanium alloy it forms a liquid phase at a temperature below the allotropic transformation temperature T of the titanium or titanium alloy constituting the said powder, (c) introducing the thus coated powder into a mold, and (d) hot compressing this powder in the mold at a certain pressure and temperature until complete densification of the powder is obtained.

U.S. Pat. No. 4,719,074 discloses a metal-ceramic composite article produced by fitting a projection formed on a ceramic member into a hole formed in a metallic member having a hardened region and an unhardened region on its surface such that the ceramic member is monolithically bonded to the metallic member and the deformed region of the metallic member resulting from the fitting is located within its unhardened range, has a high bonding force between the ceramic member and the metallic member and is adapted to be used in engine parts, such as turbocharger rotor, gas turbine rotor and the like, and other structural parts exposed to high temperature or to repeating loads, by utilizing the heat resistance, wear resistance and high strength of the ceramic.

U.S. Pat. No. 5,053,192 discloses deforming combustion products by extrusion at an certain extrusion temperature in a container made up of vertically extending segments defining spaces with one another and having a die and a heat insulated sizing member, the temperature conditions of extrusion being controlled by means of a unit having a temperature pick-up and a member receiving information from the pick-up and sending a command for moving the punch.

U.S. Pat. No. 5,139,720 discloses manufacturing a sintered ceramic material using the heat generated in a thermit reaction as a heating source, a pre-heating is applied preceding to the sintering step or a mixture comprising: (A) at least one ceramic powder, (B) at least one non-metallic powder selected from the group consisting of carbon, boron and silicon, and (C) a metal powder and/or a non-metallic powder other than the above-mentioned (B) is used. Homogeneous and dense sintered ceramic material or sintered composite ceramic material can be obtained by this method, and the fine texture thereof, and the phase constitution, the phase distribution and the like of the composite ceramic phase can be controlled sufficiently.

U.S. Pat. No. 5,701,943 discloses a metal matrix composite made by blending non-metal reinforcement powder with powder of metal or metal alloy matrix material, heating to a temperature high enough to cause melting of the matrix metal/alloy and subjecting the mixture to high pressure in a die press before solidification occurs.

As for currently known three-dimensional printing practices, consider the following internet links:

http://www.exone.com/

http://www.eos.info/systems_solutions/metal

http://www.3dsystems.com/3d-printers/production/overview

https://www.stratasysdirect.com/technologies/direct-metal-laser-sintering/

http://www.purisllc.com/

A principal advantage of the present invention is that it enables even greater, more efficient manufacture of vehicular brake rotors. Other advantages of the invention will become readily apparent to persons skilled in the art from the following specification and claims.

### SUMMARY OF THE INVENTION

There is disclosed a vehicular brake rotor component made from a Ti base powder alloy which has been 3D printed to a desired shape before one or both of its wear surfaces are coated with a 0.005 to 0.01 inch thick mixture containing about 1-40% chromium carbine. The combined product is then sintered, machined and double disc ground.

### DESCRIPTION OF PREFERRED EMBODIMENTS

More particularly, this invention addresses:
1. A vehicular brake rotor made from different percentages of Ti-6Al-4V powders
2. Its wear surfaces are made from mixtures containing between about 1 to 40% chromium carbide (or an equivalent wear material) about 0.005 to 0.01 inch thick and beyond
3. Could also be mixed with other wear materials or even a flex agent
4. Sintered at 2400 degrees F. for about 3 hours
5. Then machined and double disc ground

After manufacture of the primary brake part, such as a rotor, it may be further coated with a mixture containing about 60-99 parts by weight titanium or titanium alloy and about 1-40 parts by weight of a nonmetallic material, preferably chromium carbide. Still alternate non-metallics may include particles, fibers, whiskers and/or flakes of ceramics including silicon carbide, boron carbide, tungsten carbide, alumina, zirconium oxide, silicon nitride, boron nitride, and titanium diboride, solely or in various combinations with each other. Optionally the mixture may contain up to about 10 parts by weight of an organic binder, as explained below in more detail.

With further advances in 3D printing practices, this invention anticipates making a main brake component from a first material and having a 3D-coated layer integrally formed thereon (rather than applied in a subsequent processing step).

This invention also provides an improved method for making a vehicle brake rotor by employing 3D printing practices. A wear surface coating may be applied by plasma spraying to this 3D printed part. Or, the coating may be integrally printed as the body of the main component gets manufactured. This coating may include a bond coat containing nickel, an intermediate coat comprising zirconium oxide, chromium carbide, and nickel, and a topcoat comprising zirconium oxide and chromium carbide. The topcoat can comprise about 65 to 75 parts by weight zirconia and about 25 to 35 parts by weight chromium carbide, and the bond coat further can contain aluminum. The topcoat and the intermediate coat can contain a lesser amount of nickel and aluminum than the bond coat.

Specifically, to first and second side of each 3D printed brake rotor, there may be applied a coating comprised of a bond coat of about 4.5 wt. % aluminum and about 95.5 wt. % nickel; an intermediate coat of about 70 parts by weight zirconia, 30 parts by weight of a composition as used for the bond coat, and 10 parts by weight chromium carbide; and a top coat of about 70 parts by weight zirconium oxide and about 30 parts by weight chromium carbide.

The metallic powder used for such 3D part printings may be selected from the group consisting of titanium, steel, stainless steel, cast iron, and alloys thereof. One preferred suitable Ti powder alloy consists of Ti-6Al-4V. Still other titanium based alloys for use with this invention may include: Ti-6Al-6V-2Sn, Ti-6Al-2Sn-4Zr-2Mo, Ti-10V-2Fe-3Al and Ti-5Al-2.5Sn.

An improved titanium brake rotor is provided comprised of a central layer of a metal or metal alloy sandwiched between two outside layers comprised of a mixture of metal or metal alloy and a nonmetallic material, which outside layer provides brake wear layers on the rotor. These rotors may be formed as described herein.

In another aspect of the invention, a method for 3D printing a vehicular braking device comprises a brake rotor and hub. The rotor and hub are comprised of titanium or titanium alloy.

The improved rotor is comprised of a central layer of titanium metal or metal alloy sandwiched between two outside layers that are comprised of a mixture of titanium metal or metal alloy and a non-metallic material providing wear layers on the rotor. A hub may be diffusion bonded to the rotor to provide the braking device.

In accordance with one preferred embodiment, a brake rotor includes two opposite braking surfaces that are oriented parallel to one another. The rotor has an outer peripheral surface and an inner peripheral surface. The rotor can have a series of holes distributed on its braking surfaces and passing through the rotor, from one braking surface on one side to the braking surface on the other side of this rotor. A plurality of lugs may be arranged uniformly about the inner peripheral surface of the rotor and extend radially inwardly. Each lug is appropriately provided with a hole for connection with a hub member.

Each 3D printed rotor hereby would include a substrate having a braking surface on each of its two broad sides. Each braking surface is composed of two layers, referred to as “coats”. Thus, each braking surface is composed of a bond coat and a topcoat. Generally, the bond coat may include a thin layer comprised of nickel and the topcoat a ceramic composition of zirconium oxide and chromium carbide. Both bond coat and topcoat may be applied to the braking surfaces by plasma spraying techniques. Alternately, they may be integrally formed WITH the braking surface as part of a multiple component, multiple material 3D printing process. Following application of these bond and topcoats, the braking surface should be ground smooth.

As a general rule, increasing the chromium carbide relative to the zirconium oxide increases the wear resistance of the braking surface, while increasing the zirconium oxide relative to the chromium carbide increases the coefficient of friction of the braking surface.

Coatings composed of more than two layers may be used, even preferred, for the purpose of making transitions between different coefficients of thermal expansion less abrupt, or for introducing various kinds of materials offering special advantages.

The rotors of this invention may, or may not, have holes in their braking surfaces. Wear layers may be formed on such rotors after initial 3D printing or as part of the overall component printing process.

Suitable materials for the main braking substrate include cast iron, steel, titanium and its alloys described above, and certain titanium composites.

The brake rotor described above may also be used for some applications without any coating. For most uses however, a coating is applied to the braking surfaces. In preparation for receipt of the coating, the braking surface may be grit-blasted or sand blasted in a cabinet for capturing used media.

In one case, a braking surface may be bond coated to a thickness of about 0.005 to about 0.01 inch. That component could have its alloy applied by plasma spraying. Next, an intermediate coat would be applied by plasma spraying. Finally a topcoat could be applied thereover by plasma spraying.

Having described the presently preferred embodiments, it is to be understood that the invention may be otherwise embodied within the scope of the appended claims.

What is claimed is:

1. A method for making an automotive braking device comprises:
(a) providing a titanium or titanium alloy powder;
(b) passing the titanium or titanium alloy powder through a three-dimensional printer to make a preform brake rotor and hub;
(c) sintering said preform brake rotor and hub to form a sintered brake rotor and hub;
(d) machining said sintered brake rotor and hub; and
(e) double disc grinding said sintered brake rotor and hub to form said automotive braking device.

2. The method of claim 1 wherein said preform brake rotor has a wear layer containing about 1-40 wt. % of a non-metallic material.

3. The method of claim 2 wherein said non-metallic material is chromium carbide.

4. The method of claim 2 wherein said non-metallic material includes at least one of the group consisting of silicon carbide, boron carbide, tungsten carbide, alumina, zirconium oxide, silicon nitride, boron nitride, and titanium diboride.

5. The method of claim 1 wherein the titanium alloy powder contains about 6% aluminum, by weight, and about 4% vanadium, by weight.

6. The method of claim 1 wherein the titanium alloy powder is selected from the group consisting of: Ti-6Al-6V-2Sn, Ti-6Al-2Sn-4Zr-2Mo, Ti-10V-2Fe-3Al and Ti-5Al-2.5Sn.

7. The method of claim 1 wherein the preform brake rotor has at least one of:
(a) a plurality of apertures made by three-dimensional printing; and
(b) a plurality of lugs arranged about an inner peripheral surface of the preform brake rotor and extending radially inwardly.

8. A method for making an automotive brake rotor comprises:
(a) providing a Ti-6Al-4V powder feedstock to a 3D printer;
(b) providing the printer with a shape and dimensions for printing a brake rotor preform;
(c) forming a preform brake rotor from the Ti-6Al-4V powder;
(d) sintering said preform brake rotor; and
(e) machining said sintered brake rotor.

9. The method of claim 8, which further comprises:
(f) double disc grinding said machined brake rotor.

10. The method of claim 8, which further comprises: applying a non-metallic material coating to one or more wear surfaces of said brake rotor.

11. The method of claim 10 wherein the non-metallic material includes chromium carbide.

12. The method of claim 11 wherein the non-metallic material comprises about 1-40% (by weight) chromium carbide.

13. An automotive brake rotor made by 3D printing a titanium alloy powder into a preform; sintering the preform and machining the preform.

14. The automotive brake rotor of claim 13, which is made from a Ti-6Al-4V powder alloy.

15. The automotive brake rotor of claim 13, which is made from a Ti powder alloy selected from the group consisting of: Ti-6Al-6V-2Sn, Ti-6Al-2Sn-4Zr-2Mo, Ti-10V-2Fe-3Al and Ti-5Al-2.5Sn.

16. The automotive brake rotor of claim 13, which has at least one wear surface coated with a non-metallic material.

17. The automotive brake rotor of claim 13 wherein the non-metallic material is chromium carbide.

18. The automotive brake rotor of claim 13 wherein the non-metallic material includes at least one of the group consisting of silicon carbide, boron carbide, tungsten carbide, alumina, zirconium oxide, silicon nitride, boron nitride, and titanium diboride.

19. The automotive brake rotor of claim 13 wherein the preform has at least one of:
(a) a plurality of apertures made by three-dimensional printing; and
(b) a plurality of lugs arranged about an inner peripheral surface of the preform brake rotor and extending radially inwardly.
